(19) United States
(12) Patent Application Publication
(10) Pub. No.: US 2008/0157735 A1
(43) Pub. Date: Jul. 3, 2008

(54) Adaptive pole and zero and pole zero cancellation control low drop-out voltage regulator

(75) Inventors: Yen-Jen Liu, Hsinchu (TW); Yung-Pin Lee, Hsinchu (TW); Chung-Wei Lin, Hsinchu (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE, Hsinchu (TW)

(21) Appl. No.: 11/783,357

(22) Filed: Apr. 9, 2007

(30) Foreign Application Priority Data
Dec. 28, 2006 (TW) 095149579

(51) Int. Cl. G05F 1/00

(52) U.S. Cl. 323/280

(57) ABSTRACT

A adaptive pole and zero and Pole-Zero Cancellation Control Low Drop-Out (LDO) regulator is provided, which includes a regulation unit, an error amplifier, a Miller Effect Pole control unit, a Pole Zero Cancellation delay unit, and a feedback network. Pole and Zero could be adaptive regulated depend on various loads and maintain stably in a perfect phase margin.

### CROSS-REFERENCE TO RELATED APPLICATIONS

This non-provisional application claims priority under 35 U.S.C. §119(a) on Patent Application No(s). 095149579 filed in Taiwan, R.O.C. on Dec. 28, 2006, the entire contents of which are hereby incorporated by reference.

### BACKGROUND

1. Field of the Invention

The present invention relates to a low drop out (LDO) regulator, and more particularly to an adaptive pole and zero and pole-zero cancellation control LDO regulator.

2. Related Art

A related technology in controlling a low drop out (LDO) regulator is disclosed in U.S. Pat. No. 6,603,292. The patent is tilted “LDO regulator having an adaptive zero frequency circuit”. In general, when a feedback signal transmits in a feedback circuit, a phase shift will occur, and the phase shift can be defined as an amount of change in phase contributed by the transmission of the feedback signal in the feedback circuit. An ideal phase differential between the negative feedback and the source signal is 180 degrees, therefore the difference between the ideal phase differential and the actual phase differential, depending on the magnitude of the difference, will affect the stability of the LDO regulator. If the difference between the ideal phase differential and the actual phase differential reaches (positive or negative) 180 degrees, the feedback signal will be the same as the source signal, which will result in an unstable LDO regulator. Thus, in order to ensure the stability of the LDO regulator, the phase margin should be higher than a minimum level. The phase margin is defined as the degree difference between the total phase shift of the feedback signal and the ideal 180 degree from a source signal under the same gain frequency. In the prior art, shown in FIG. 1A, a zero that is adjustable with a load is generated to improve the stability. The principle is that a gm3 is operated in the triode region and a gm1 is used to detect the current of the power MOS. Therefore, when the load current is high, the current of the power MOS will also be high and so does a mirror current which goes through the gm2 path. At this moment, the gm2 value will become larger, so as to make the voltage of the gm2 gate increase and also brings the increase of the gm3 value. As shown in FIG. 1B, the equivalent impedance R1 (inversely proportional to the gm3) will also decrease, so that Zero (Z1) will fall in the high frequency region. On the contrary, when the load current is low, the current of the power MOS will also be low and so does the mirror current which goes through the gm2 path. The gm2 value will then decrease, which makes the voltage of the gm2 gate decrease and brings the decrease of the gm3 value. Therefore the equivalent impedance R1 (inversely proportional to the gm3) will also increase so as to make the Zero (Z1) fall in the low frequency region as shown in FIG. 2.

In the technology described in the prior art, although zero can move with the load current, however it is not under control so that the pole-zero cancellation may be still happen. The pole-zero cancellation coefficient β equals R1/R2; therefore, when the load current is low, the pole and the zero are almost cancel each other such that zero barely helps stabilize the circuit. As a result, the phase margin will decrease, which makes the performance of dynamic reaction of the LDO regulator worse in low load current than in high load current. FIG. 3 shows the phase margin and the load current of a conventional LDO regulator, where the phase margin in the low current drops 60 degrees to around 40 degrees because of the zero effect. FIG. 4 shows a jitter measurement diagram of a conventional LDO regulator with a load current from 0 to 150 mA. From the figure, it can be found that a little jitter still occurs.

Therefore, how to improve the LDO regulator to make the dynamic reaction performance of the LDO regulator not be affective by the cancellation when the load current is low becomes an important issue.

### SUMMARY OF THE INVENTION

In general, when an LDO regulator is compensated, the compensation will be focused on the non-dominant pole. Take the dominant pole at the output node as an example, when the load current is high, the loop gain of the LDO regulator decreases because of the decrease of equivalent output impedance, and the dominant pole will move toward high frequency so that the bandwidth of the loop will become larger. On the contrary, when the load current is low, the loop gain of the LDO regulator will increase because of the increase of the equivalent output impedance, and the dominant pole will move toward low frequency so that the bandwidth of the loop will become smaller. However, the zero compensation method of the present invention is different from that of prior art with a fixed compensation, wherein that a zero and pole can change with the load current in a circuit is adopted by the present invention. In other words, when the load current is high, the bandwidth is also large and the zero will locate at the high frequency region. In addition, the dominant pole will be pushed toward to lower frequency and an undesired pole will be pushed out of the bandwidth of the loop. When the load current is low, the bandwidth is small and the zero will move toward low frequency. In addition, the non-dominant pole will fall in the high frequency. Such design can make LDO regulator obtain enough compensation no matter the load current is high or low and produce a good phase margin. When the phase margin is becoming better, the jitter of the dynamic waveform will become smaller when the LDO regulator performs load transient (i.e. the load current suddenly becomes higher or lower), and even disappear when the phase margin reaches a certain level. Therefore, it is very useful for circuits which are sensitive to the voltage jittering, such as a RF circuit, an ADC and so on. Such LDO regulator not only can output stable voltage but also has excellent ability to avoid power supply noise, so that the overall circuit performance may be improved.

### BRIEF DESCRIPTION OF THE DRAWINGS

The present invention will become more fully understood from the detailed description given below, which is for illustration only and thus is not limitative of the present invention, wherein:

FIG. 1A is a circuit diagram of a conventional LDO regulator;

FIG. 1B is an equivalent circuit diagram of the FIG. 1A;

FIG. 2 is a schematic diagram of phase shift of pole-zero of a conventional LDO regulator under different loads;

FIG. 3 is a schematic diagram of phase margin and load current of a conventional LDO regulator;

FIG. 4 is a schematic diagram of jitter measurement of a conventional LDO regulator under a load current from 0 to 150 mA;

FIG. 5A is a block diagram of the LDO regulator used by the present invention;

FIG. 5B is a circuit diagram of the LDO regulator used by the present invention;

FIG. 5C is a signal flow graph of the LDO regulator used by the present invention;

FIG. 5D is a schematic diagram of pole-zero phase shift of the LDO regulator used by the present invention under different loads;

FIG. 6 is a schematic diagram of phase margin and load current of the LDO regulator used by the present invention; and

FIG. 7 is a schematic diagram of jitter test of the LDO regulator used by the present invention under a load current from 0 to 150 mA.

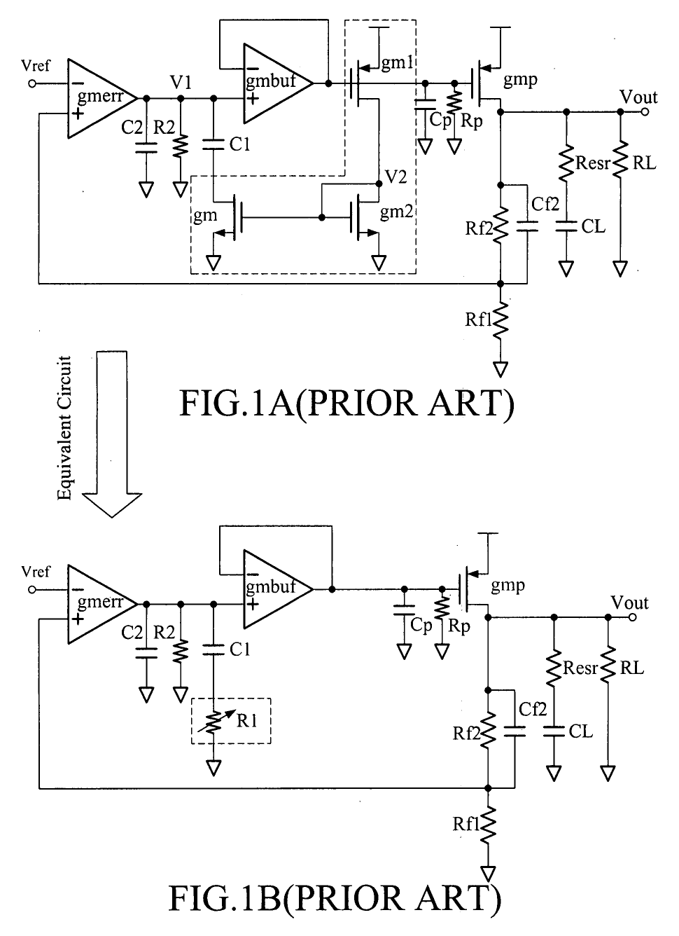

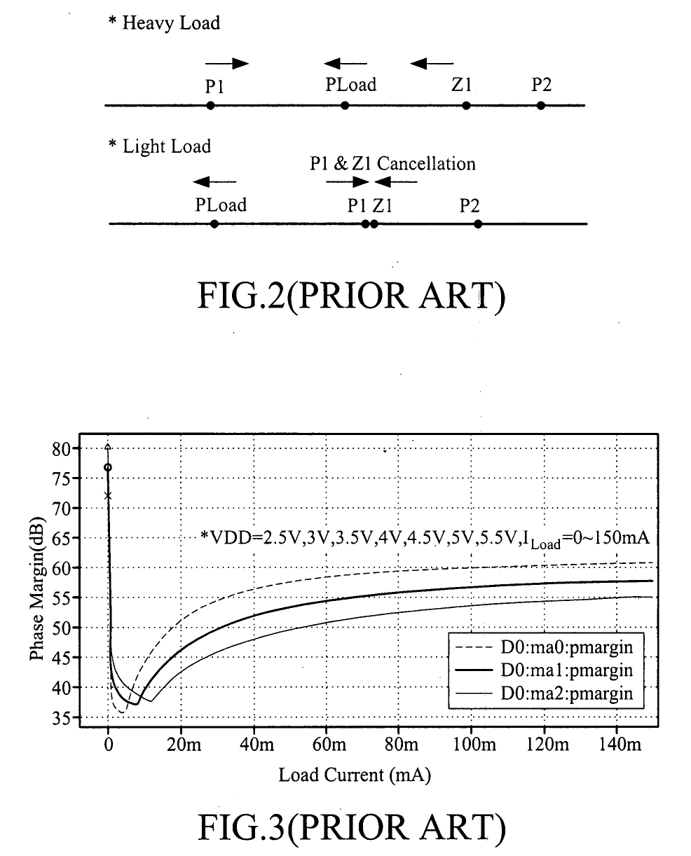

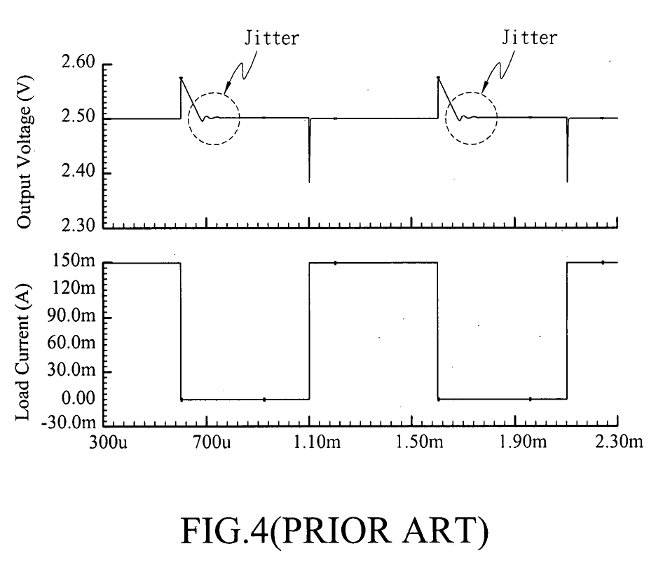

### DETAILED DESCRIPTION

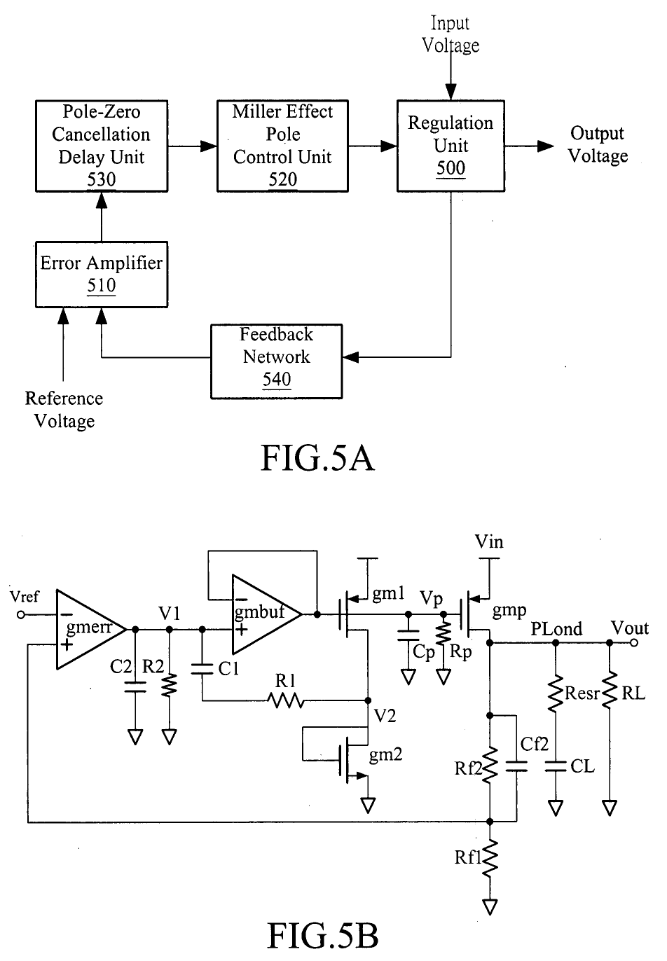

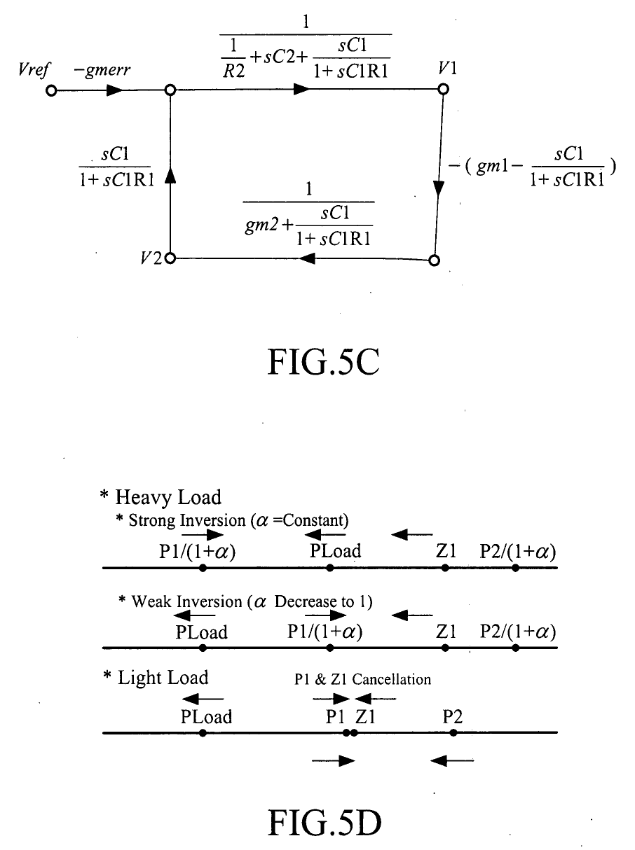

FIG. 5A is a block diagram of the LDO regulator used by the embodiment. The LDO regulator is an adaptive pole, zero, and pole-zero cancellation control LDO regulator. The LDO regulator includes a regulation unit 500, an error amplifier 510, a Miller Effect Pole control unit 520, a Pole-Zero Cancellation delay unit 530, and a feedback network 540. The pole and zero of LDO regulator of the embodiment can be adaptively adjusted with the change of the load, so that under all the load circumstances, the stability of the LDO regulator can be maintained in an ideal phase margin.

FIG. 5B is a circuit diagram of the LDO regulator used by the embodiment. The LDO regulator includes a regulation unit 500, an error amplifier 510, a Miller Effect Pole control unit 520, a Pole-Zero Cancellation delay unit 530, and a feedback network 540. The regulation unit 500 is a p-type metal oxide semiconductor (PMOS) or an n-type metal oxide semiconductor (NMOS). PMOS will be the preference. It includes an input node Vin, an output node Vout and a control node, where the input node receives an input signal and responses to a control signal received by the control node by outputting an output signal from the output node. The error amplifier 510 has an inverting input node connecting to a reference voltage Vref and an output node connecting to a first node V1. The Miller Effect Pole control unit 520 includes a PMOS connecting an NMOS in series, where a source of the PMOS connects to the input node, a gate connects to the first node V1 and the control node, a drain connects to the drain and gate of the NMOS in series through a second node V2, and the source of the NMOS is grounding. The Pole-Zero Cancellation delay unit 530 connects to the first node V1, the second node V2, and the control node. The Pole-Zero Cancellation delay unit 530 further includes a buffer, where the buffer has an inverting input node connecting to the control node, and a resistor (R1) and capacitor (C1) series connection connecting to the first node and the second node and using the first node as a non inverting input node of the buffer, where the first node further parallel connects a resistor (R2) and capacitor (C2) parallel connection. The feedback network 540 connects to the output node Vout and a non inverting output node of the error amplifier 510. In addition, the feedback network 540 is a voltage divider, wherein one voltage divided node connects to the non inverting input node of the error amplifier.

FIG. 5C is a signal flow graph of the LDO regulator used by the embodiment, wherein the operation mainly has three regions:

$$Region A . Strong Inversion ( α = \frac{gm 1}{gm 2} = Constant )$$

$$Z 1 = \frac{1}{2 π C 1 ( R 1 + \frac{1}{gm 2} ) }$$

$$P 1 = \frac{1}{2 π C 1 ( 1 + gm 1 / gm 2 ) R 2}$$

$$P 2 = \frac{1}{2 π C 2 \frac{R 1}{( 1 + gm 1 / gm 2 )}}$$

In the above formulas, R1 is the resistance value for the resistor of the resistor-capacitor series connection, C1 is the capacitance value for the capacitor of the resistor-capacitor series connection, gm1 is the first transconductance of the PMOS, gm2 is the second transconductance of the NMOS, R2 is an equivalent resistance outputted by the error amplifier, and C2 is a equivalent capacitance outputted by the error amplifier.

The region A happens when the current is high about tens of mA to hundreds of mA. Since the output current is high at this moment, the outputted equivalent impendence is very small. Therefore as shown in FIG. 5D, in order to stabilize the loop, PLoad usually is the non-dominant pole and V1 will be the dominant pole at this time. The pole of this circuit can be automatically adaptive because C1 has a Miller effect, where the Miller coefficient α=gm1/gm2, which can push the dominant pole (P1) (1+gm1/gm2) times inside further and also push the undesired non dominant pole (P2) (1+gm1/gm2) times outside further, to make the phase margin of the entire loop become much better, and maintain the stability of the loop. At this time, the adaptive zero is determined by C1 and R1 (R1 has a proportion much more than the 1/gm2) to compensate PLoad, so that the stability of the loop can obtain an optimum compensation.

$$Region B . Weak Inversion ( α = \frac{gm 1}{gm 2} ≅ 1 )$$

$$Z 1 = \frac{1}{2 π C 1 ( R 1 + \frac{1}{gm 2} )}$$

$$P 1 = \frac{1}{2 π C 1 ( 2 ) R 2}$$

$$P 2 = \frac{1}{2 π C 2 \frac{R 1}{( 2 )}}$$

In the above formulas, R1 is the resistance value for the resistor of the resistor-capacitor series connection, C1 is the capacitance value for the capacitor of the resistor-capacitor series connection, gm2 is the second transconductance of the NMOS, R2 is an equivalent resistance outputted by the error amplifier, and C2 is an equivalent capacitance outputted by the error amplifier.

When the current is becoming small about several mA to tens of mA, the outputted resistance will increase slowly. Therefore PLoad will also move toward low frequency slowly. Thus, at this time, the dominant pole will be PLoad. When the current decreases to a certain level, gm1 and gm2 will slowly move into a weak inversion status, where gm at this time is almost only related to the current (α decreases to 1), so the Miller effect of P1 becomes weaker, approximately one fold; therefore, P1 (non-dominant pole) can fall into a high frequency region to improve the stability. Since the current of gm2 becomes smaller, the gm2 also become smaller and the proportion of 1/gm1 will also increase. As a result, Z1 at this time will move toward low frequency upon the current becoming small. Therefore, in overview, when the load current decreases, the bandwidth of the loop reduces also. Hence, zero can move toward low frequency region, to compensate the non dominant pole (P1) effectively. By doing so, the loop can maintain a good phase margin and stability.

$$Region C . Light Load$$

$$Z 1 = \frac{1}{2 π C 1 ( \frac{1}{gm 2} )}$$

$$P 1 = \frac{1}{2 π C 1 ( \frac{1}{gm 2} )}$$

$$P 2 = \frac{1}{2 π C 2 R 2}$$

In the formulas above, C1 is the capacitance value for the capacitor of the resistor-capacitor series connection, gm2 is the second transconductance of the NMOS, R2 is an equivalent resistance outputted by the error amplifier, and C2 is an equivalent capacitance outputted by the error amplifier.

When the current is becoming small and reaches several mA or less, PLoad will move further toward low frequency region, and P1 will become closer to Z1 so there will be a cancellation effect and the pole-zero cancellation coefficient (β) will be

$$\frac{R 2}{( \frac{1}{gm 2} )} .$$

However, since a weak inversion is created to slow down the happening of pole-zero cancellation in order to control the pole-zero cancellation, when the pole-zero cancellation occurs, PLoad is already in a very low frequency region and the bandwidth of the loop is also at a frequency much lower than that of the non-dominant pole (P2). Therefore, the effect of P2 will be small, so that the loop still can maintain good phase margin and stability.

According to the description above, in order to maintain the stability of the loop, three operation regions are created to control the stability of LDO regulator. First, in heavy load (strong inversion), R1 is utilized to slow down the speed of the pole-zero cancellation, and Miller Effect is used to push the dominant pole to the low frequency region and push the undesired pole to higher frequency region far away from the bandwidth of the loop to improve the phase margin and the stability. Second, in the heavy load (weak inversion), zero will be adjusted according to the load current, to move to low frequency region so that the compensation can be more efficient. At this time, the zero is adaptive and the Miller Effect is not so obvious; therefore, the non-dominant pole can be at a higher frequency position, and the pole also has an adaptive effect at this moment. Also, because the dominant pole is PLoad and the non-dominant pole is v1, the phase margin and stability of the loop will not be affected and still can be in a good condition. Third, in the light load, where has a low current, the pole-zero cancellation will happen, and zero will lose its effect, however since R1 is used to control the pole-zero cancellation, the pole-zero cancellation only will happen when the dominant pole moves to a low frequency region far enough and the frequency of the bandwidth is lower than that of the non-dominant pole. Therefore, the phase margin and the stability of the LDO regulator can be maintained. In summary, the adaptive pole and zero and pole-zero cancellation control LDO regulator based on the embodiment can automatically adjust the pole or the zero to maintain the good stability under different load current, which will be very helpful to some circuits sensitive to jittering. Also, it can overcome the difficulty faced in compensating the LDO regulator, and maintain a good phase margin and stability within the operating range of large load current and voltage.

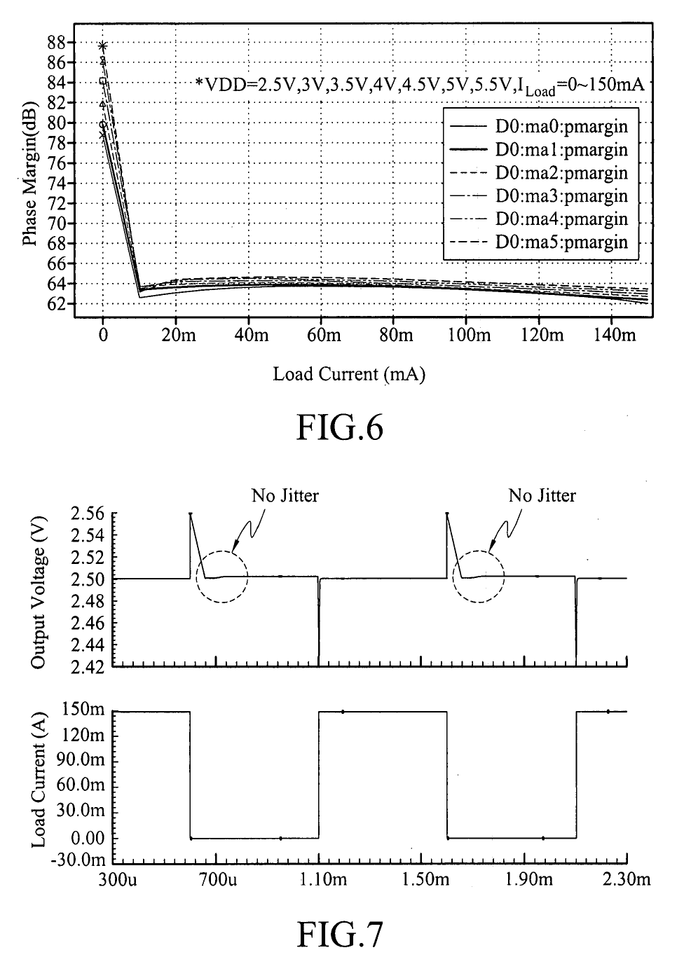

FIG. 6 is a diagram of phase margin and load current of the LDO regulator used by the embodiment. Because the pole-zero cancellation is under control, the phase margin of the low current can be maintained around 64 degree, and will not become worse because of the change of load current. FIG. 7 is the jitter measurement diagram of the LDO regulator under the load current 0 to 150 mA based on the embodiment. It can be inferred from the figure that the jittering is getting better.

While the illustrative embodiments of the invention have been set forth for the purpose of disclosure, modifications of the disclosed embodiments of the present invention as well as other embodiments thereof may occur to those skilled in the art. Accordingly, the appended claims are intended to cover all embodiments, which do not depart from the spirit and scope of the present invention.

What is claimed is:

1. An adaptive pole and zero and pole-zero cancellation control LDO regulator, comprising:
a regulation unit, including an input node, an output node, and a control node, wherein the input node of the regulation unit receives an input signal, the regulation unit responds a control signal received by the control node, and the regulation unit provides an output signal through the output node;
an error amplifier, including an inverting input node connecting to a reference voltage and an output node connecting to a first node;
a Miller Effect Pole control unit, including a p-type metal oxide semiconductor (PMOS) connecting to a n-type metal oxide semiconductor (NMOS), wherein a source of the PMOS connects to the input node, a gate of the PMOS connects to the first node and the control node, a drain of the PMOS connects to a drain and gate of the NMOS in series through a second node and a source of the NMOS is grounding;
a Pole-Zero Cancellation delay unit, connecting to the first node, the second node and the control node; and
a feedback network, connecting to the output node and a non inverting output node of the error amplifier.

2. The LDO regulator of claim 1, wherein the regulation unit is a p-type metal oxide semiconductor or an n-type metal oxide semiconductor.

3. The LDO regulator of claim 1, wherein the Pole-Zero Cancellation delay unit further includes a buffer, wherein an inverting input node of the buffer connects to the control node; and a resistor-capacitor series connection connecting to the first node and the second node wherein the first node is used as a non inverting input node of the buffer.

4. The LDO regulator of claim 3, wherein the first node further parallel connects to a resistor-capacitor parallel connection.

5. The LDO regulator of claim 4, wherein P1 is obtained by following formula
$$P 1 = \frac{1}{2 π C 1 ( 1 + gm 1 / gm 2 ) R2} ;$$
wherein C1 is a capacitance value for resistor of the resistor-capacitor series connection, gm1 is a first transconductance of the PMOS, gm2 is a second transconductance of the NMOS, and R2 is an equivalent resistance outputted by the error amplifier.

6. The LDO regulator of claim 4, wherein P2 is obtained by following formula:
$$P 2 = \frac{1}{2 π C 2 \frac{R 1}{( 1 + gm 1 / gm 2 )}} ,$$
wherein C2 is an equivalent capacitance outputted by the error amplifier, gm1 is a first transconductance of the PMOS, gm2 is a second transconductance of the NMOS, and R1 is a resistance value for resistor of the resistor-capacitor series connection.

7. The LDO regulator of claim 4, wherein P2 is obtained by following formula:
$$Z 1 = \frac{1}{2 π C 1 ( R 1 + \frac{1}{gm 2} )} ,$$
wherein C1 is a capacitance value for capacitance of the resistor-capacitor series connection, gm2 is a second transconductance of the NMOS, and R1 is a resistance value for resistance of the resistor-capacitor series connection.

8. The LDO regulator of claim 1, wherein the feedback network is a voltage divider, wherein one voltage divided node connects to the non inverting input node of the error amplifier.
